(19) United States
(12) Patent Application Publication
(10) Pub. No.: US 2025/0209408 A1
(43) Pub. Date: Jun. 26, 2025

(54) DECISION MODEL COMPRESSION FOR EFFICIENT PROCESSING AND STORAGE OF MULTI-CONDITION WORKFLOWS

(71) Applicant: INTUIT INC., Mountain View, CA (US)

(72) Inventors: Shyamalendu TRIPATHY, Bangalore (IN); Bhavishya TOLANI, Bangalore (IN); Sandeep GUPTA, Bangalore (IN); Yash AGARWAL, Bangalore (IN); Nivedita NAYAK, Bangalore (IN); Manupriyam JINDAL, Bangalore (IN)

(21) Appl. No.: 18/391,919

(22) Filed: Dec. 21, 2023

(51) Int. Cl. G06Q 10/067

(52) U.S. Cl. CPC G06Q 10/067

(57) ABSTRACT

A method for compressed decision model object generation and processing. Embodiments include receiving configuration data specifying a first condition of a workflow, an action of the workflow that depends on the first condition being true, and a second condition of the workflow that depends on the first condition being false. Embodiments include generating a first entry in a decision model object comprising a first index value, the first condition, and an identifier of the action as a conditional output for the first entry that depends on the first condition. Embodiments include generating a second entry in the decision model object comprising the first index value and a second index value as a default output for the second entry. Embodiments include generating a third entry in the decision model object comprising the second index value, and the second condition. Embodiments include executing the workflow by serially processing the decision model object.

Aspects of the present disclosure relate to compression of decision model objects for efficient processing and storage of multi-condition workflows. In particular, embodiments involve a compression engine that generates a single decision model object for a multi-condition workflow with a particular structure that allows for efficient evaluation and conversion of the workflow logic.

### BACKGROUND

Every year millions of people around the world utilize software applications to assist with countless aspects of life. Many software applications allow users to configure workflows by which certain actions are taken under certain conditions. For example, a software application may provide automation functionality, and a user may configure such automation functionality by specifying conditions under which automated actions are to be performed.

Certain existing techniques for workflow configuration involve generating a decision model and notation (DMN) object for each individual condition and then using DMN objects for conditions to evaluate workflows (e.g., as events occur in a software application). DMN is a standard approach for describing and modeling repeatable decisions. For example, evaluating a workflow may involve multiple network calls associated with loading, initiating, and reporting results of evaluating each individual DMN object. These existing techniques are resource- intensive, and generally do not scale well. For example, it is difficult to support multi-condition workflows (e.g., with dependencies among the multiple conditions) when separate DMN objects and associated computing resource costs are required for each individual condition.

Therefore, there is a need for improved techniques for workflow configuration and processing in software applications, particularly for complex workflows that involve multiple conditions.

### BRIEF SUMMARY

Aspects and advantages of embodiments of the present disclosure will be set forth in part in the following description, or may be learned from the description, or may be learned through practice of the embodiments.

A method for compressed decision model object generation and processing includes: receiving configuration data specifying: a first condition of a workflow; an action of the workflow that depends on the first condition being true; and a second condition of the workflow that depends on the first condition being false; generating a first entry in a decision model object comprising: a first index value; the first condition; and an identifier of the action as a conditional output for the first entry that depends on the first condition; generating a second entry immediately following the first entry in the decision model object comprising: the first index value; and a second index value as a default output for the second entry; generating a third entry immediately following the second entry in the decision model object comprising: the second index value; and the second condition; and executing the workflow in a software application by serially processing the decision model object.

Further embodiments include a non-transitory computer-readable storage medium storing instructions that, when executed by a computer system, cause the computer system to perform the method set forth above. Further embodiments include a system comprising at least one memory and at least one processor configured to perform the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment including components related to compressed decision model object generation and processing according to embodiments of the present disclosure.

FIG. 2 depicts an example user interface screen relating to workflow configuration for compressed decision model object generation and processing according to embodiments of the present disclosure.

FIG. 3 is an illustration of an example decision model object according to embodiments of the present disclosure.

FIG. 4 is an illustration of an example business process model object according to embodiments of the present disclosure.

FIG. 5 depicts example operations related to compressed decision model object generation and processing according to embodiments of the present disclosure.

FIGS. 6A and 6B depict example processing systems related to compressed decision model object generation and processing according to embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to compressed decision model object generation and processing for workflows in software applications.

A workflow in a software application may include one or more conditions and one or more actions, such as automation logic that causes certain actions to be performed when certain conditions are met. Conventional techniques for configuring workflows in software applications have a variety of drawbacks. For example, existing techniques generally involve generating a separate decision model object for each separate condition. As used herein, a decision model object may refer to a decision model and notation (DMN) object or another similar object that specifies conditions and actions of a workflow in a sequential manner. Processing a decision model object generally requires multiple network calls and utilization of other computing resources (e.g., processing and memory resources) associated with loading, initiating, and reporting results of evaluating the decision model object. Thus, using a separate decision model object for each condition does not scale well, and is particularly inefficient for multi-condition workflows, such as with dependencies among multiple conditions. Existing techniques for generating decision model objects do not provide a mechanism for supporting multiple conditions in a single decision model object.

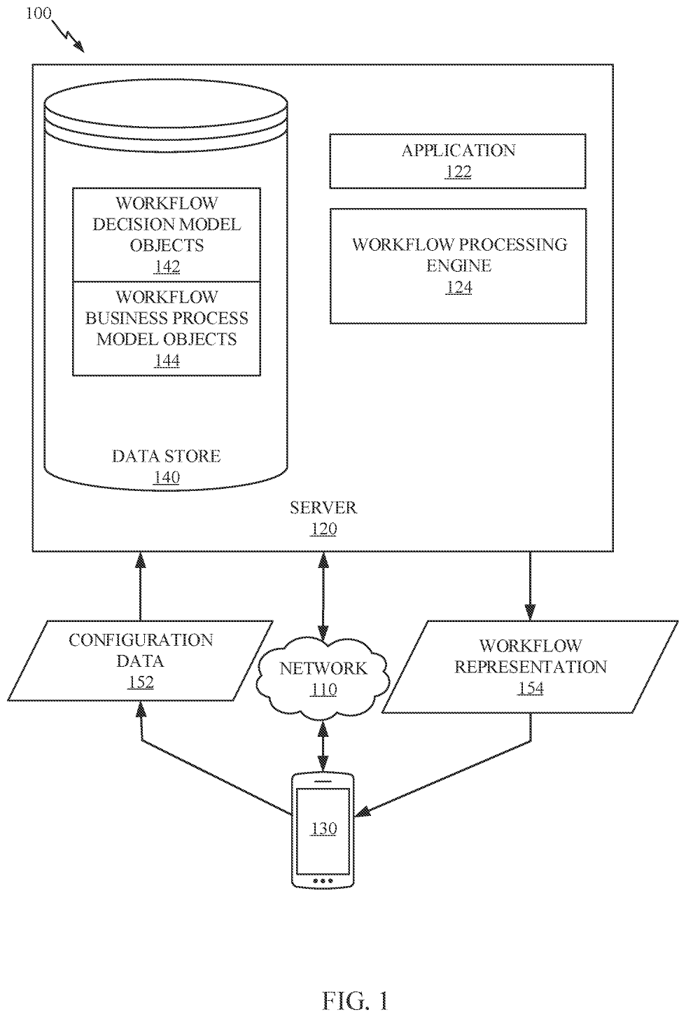

Embodiments of the present disclosure overcome these problems with existing techniques through a particular process by which workflow configuration data is used to generate a compressed decision model object that includes logic for evaluating multiple conditions and that can be efficiently processed to evaluate the workflow and/or to convert the decision model object back into a workflow language for displaying a visual representation of the workflow to the user (e.g., so that the user can review or update the configuration of the workflow). For example, rather than generating separate decision model objects for multiple conditions, a workflow processing engine generates a single decision model object for a multi-condition workflow in a particular manner that uses index values and ordering to configure the decision model object to be efficiently processed in a serial manner, as described in more detail below with respect to FIGS. 1-3.

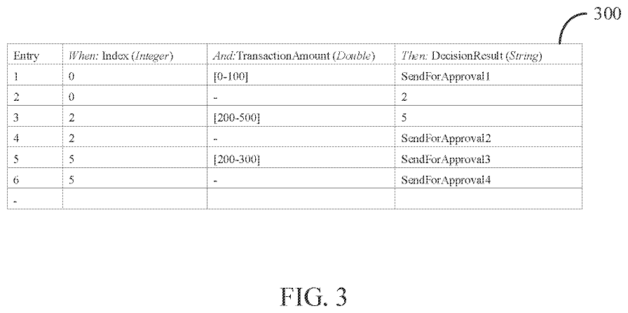

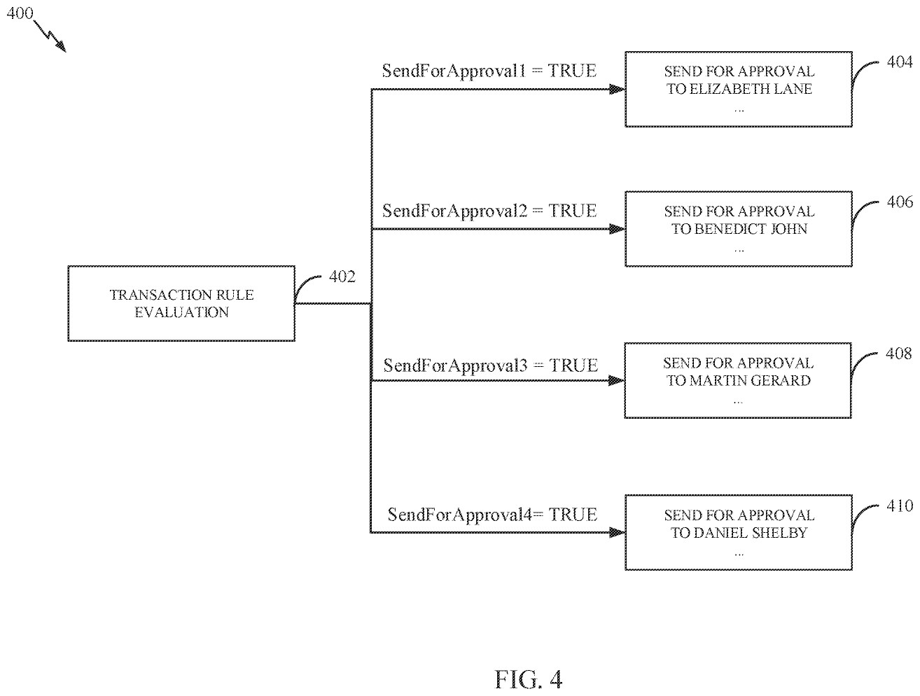

For example, a decision model object may be generated such that each of a series of sequential entries specifies an index value, a condition (if appropriate), and an output that either indicates an identifier of an action or an index value of a next step in the decision logic. An example of generating such a decision model object is described below with respect to FIG. 3. The decision model object can be processed serially in order to execute a workflow by starting with the first entry and continuing through subsequent entries as appropriate based on outputs of each entry as it is traversed. Action identifiers output from the decision model object can be mapped to action logic via a business process model object, as described in more detail below with respect to FIG. 4. A business process model object may refer to a business process model and notation (BPMN) object or another similar object that maps action identifiers to details that allow the actions to be performed. If an action identifier is output by the decision model object, the action identifier may be mapped to action logic using the business process model object, and the action logic may then be used to perform the action.

Rather than utilizing separate decision model objects for multiple conditions, which requires multiple network calls and other resource utilization associated with loading, initiating, evaluating, and reporting results of evaluating each decision model object, techniques described herein allow a single decision model object to be used for multiple conditions in a workflow, thereby significantly reducing the network calls and resource utilization by only requiring the network calls and other resource utilization associated with loading, initiating, evaluating, and reporting results of evaluating a single decision model object for a workflow.

Techniques described herein provide multiple technical improvements over existing techniques for implementing configurable workflows in software applications. For example, as compared to existing techniques that require the use of separate decision model objects for each condition, embodiments of the present disclosure are able to generate a single decision model object for multiple conditions in an efficient serialized form. Thus, techniques described herein avoid the network calls and computing resource utilization that would otherwise occur as a result of generating and processing separate decision model objects for each individual condition, and thereby improve the functioning of computing devices involved. Furthermore, techniques described herein allow multi-condition workflows to be configured and executed in a scalable manner that could not be achieved using existing techniques that support only one condition per decision model object, thereby further improving the functioning of computing applications and devices involved.

Additionally, by configuring a decision model object with multiple conditions in an efficient manner for index-based traversal through conditional logic, embodiments of the present disclosure allow workflows to be executed in a resource-efficient manner by processing such a decision model object and allow a visual representation of a workflow to be reconstructed in a resource-efficient manner based on such a decision model object.

### Example Computing Environment for Compressed Decision Model Object Generation and Processing

FIG. 1 illustrates an example computing environment 100 for automated workflow assistance according to embodiments of the present disclosure.

Computing environment 100 includes a server 120 and a client 130 connected over network 110. Network 110 may be representative of any type of connection over which data may be transmitted, such as a wide area network (WAN), local area network (LAN), cellular data network, and/or the like.

Server 120 includes an application 122, which generally represents a computing application that users interacts with over network 110, such as via computing devices (e.g., a user may interact with application 122 via client 130). In some embodiments, application 122 is accessed via a user interface associated with client 130.

According to one embodiment, application 122 is an electronic financial accounting system that assists users in book-keeping or other financial accounting practices. Additionally, or alternatively, the financial management system can manage one or more of tax return preparation, banking, investments, loans, credit cards, real estate investments, retirement planning, bill pay, and budgeting. In such an embodiment, workflows described herein may relate to automatically performing actions (e.g., prompting a particular individual for approval) upon the occurrence of certain conditions related to financial management (e.g., when an invoice is created within the software application that has an amount over a threshold). In other embodiments, application 122 provides other, non-financial functionality, and involves workflows that do not necessarily relate to finances. Generally, application 122 allows users to configure workflows in which particular actions are automatically performed upon the occurrence of particular conditions. Workflows may also relate to filtering or searching through a data set, such as specifying conditions (e.g., nested or otherwise) under which results should be displayed. Application 122 can be a standalone system, or can be integrated with other software or service products provided by a service provider.

Data store 140 generally represents a data storage entity such as a database or repository that stores data relating to application 122 and/or workflow processing engine 124, including workflow decision model objects 142 and workflow business process model objects 144. Workflow decision model objects 142 and workflow business process model objects 144 generally include data related to workflows configured via application 122. An example of a workflow decision model object 142 is described below with respect to FIG. 3. An example of a workflow business process model object 144 is described below with respect to FIG. 4. A workflow generally indicates conditions and actions that are to be performed based on the conditions, and workflow decision model objects 142 and workflow business process model objects 144 allow the conditions to be evaluated as events occur in order to determine whether to perform actions, and also allow the a visual representation of a workflow to be reconstructed for display, such as for further configuration of the workflow.

A workflow processing engine 124 generally provides functionality related to processing workflow configuration data, generating workflow decision model objects 142 and workflow business process model objects 144, and processing workflow decision model objects 142 and workflow business process model objects 144 to execute workflows and reconstruct visual representations of workflows. While shown separately, some or all of the functionality described herein with respect to workflow processing engine 124 may alternatively be part of application 122 and/or may be implemented by one or more additional components.

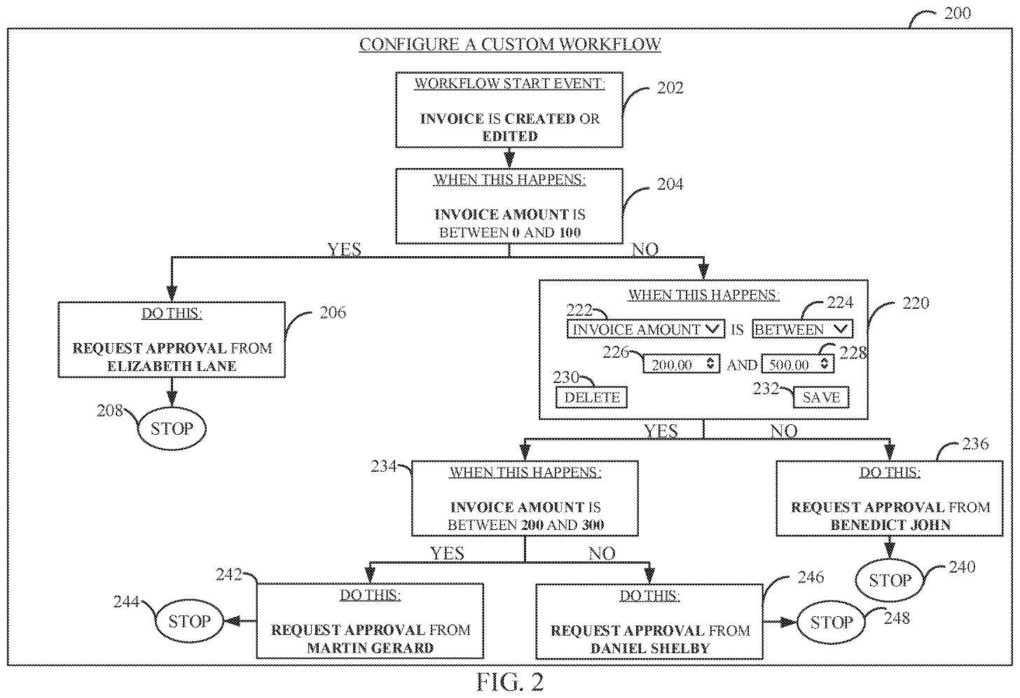

In an example, as described in more detail below with respect to FIG. 2, a user may interact with a user interface (e.g., via client 130) in order to configure a workflow for application 122, and the resulting configuration data 152 may be provided to server 120. Configuration data 152 may specify one or more conditions and/or one or more actions.

Workflow processing engine 124 may then process configuration data 152 in order to generate a workflow decision model object 142 and a workflow business process model object 144 for resource-efficient processing of the workflow. As described in more detail below with respect to FIG. 3, workflow processing engine 124 may create a workflow decision model object 142 by adding sequential entries to the object that specify index values, conditions (as appropriate), and outputs of the entries that indicate action identifiers or index values of entries that represent next steps in evaluation logic. As described in more detail below with respect to FIG. 4, workflow processing engine 124 may create a workflow business process model object 144 that maps action identifiers to action logic that allows the actions to be performed.

Workflow processing engine 124 may also execute a workflow that was configured via configuration data 152 by serially processing the workflow decision model object 142 that was generated based on configuration data 152, such as based on a depth first search (DFS). For example, as described in more detail with respect to FIG. 3, workflow processing engine 124 may begin at the first entry in the workflow decision model object 142, determine whether any condition indicated in the entry is true, and then determine an output of the entry accordingly. If no output applies (e.g., if the output is dependent on a condition that is not true), then workflow processing engine 124 may proceed to the next entry. If an output of the entry indicates a particular index value, then workflow processing engine 124 may proceed to the first entry in the workflow decision model object 142 having the particular index value. If an output of the entry indicates an action identifier, then workflow processing engine 124 may use the workflow business process model object 144 corresponding to the workflow in order to map the action identifier to action logic for performing the action. Workflow processing engine 124 may then use the action logic to perform the action.

Furthermore, if a user requests to view the workflow that was configured via configuration data 152, such as via a workflow configuration screen in a user interface (e.g., like that shown in FIG. 2), workflow processing engine 124 may use the workflow decision model object 142, such as via a DFS, to reconstruct a workflow representation 154 to provide to client 130 for display to the user. Workflow representation 154 may be based on a workflow language that workflow processing engine 124 generates based on the workflow decision model object 142, and may generally comprise a visual representation of the workflow such as that shown in FIG. 2. For example, workflow processing engine 124 may travers the workflow decision model object 142 based on the structure of the object that is known to workflow processing engine 124 (e.g., following the logic of the workflow as represented in the workflow decision model object).

Workflow representation 154 may be provided to the user via the user interface (e.g., the workflow representation 154 may be sent to client 130 and displayed via the user interface on client 130). For example, workflow representation 154 may allow the user to review the configuration of the workflow and/or edit the configuration of the workflow.

In alternative embodiments, all components described herein may be implemented on a single device or on more or fewer devices than those shown.

### Example User Interface Screen

FIG. 2 illustrates an example user interface screen 200 related to compressed decision model object generation and processing according to embodiments of the present disclosure. For example, user interface screen 200 may represent a screen of application 122 of FIG. 1 accessed via a user interface displayed on client 130 of FIG. 1. Generally, user interface screen 200 provides user interface controls by which a user is enabled to configure a custom workflow. In an example, user interface screen 200 provides drag and drop functionality, such as allowing a user to drag condition elements and action elements (e.g., from a list or section of the user interface that is not shown) onto a canvas, or otherwise allows the user to specify conditions, actions, and relationships between such conditions and actions.

In the depicted example, a workflow start event 202 (e.g., which may be an example of a condition) has been configured, indicating that the workflow begins when an invoice is created or edited. Following the workflow start event 202, another condition 204 has been configured indicating an invoice amount between 0 and 100, and a “yes” path and “no” path for condition 204 are defined. The yes path for condition 204 indicates how the workflow should proceed when condition 204 is satisfied (e.g., when an invoice amount is between 0 and 100), and the no path for condition 204 indicates how the workflow should proceed when condition 204 is not satisfied (e.g., when an invoice amount is not between 0 and 100).

For the yes path of condition 204, an action 206 has been configured, indicating that approval should be requested from a particular individual (Elizabeth Lane). Action 206 is followed in the workflow by a stop action 208, indicating that the workflow ends. In alternative configurations (not shown), an action could be followed by another action or condition.

For the no path of condition 204, another condition 220 is currently being configured in the depicted example. Via controls 222, 224, 226, and 228, the user has selected that an invoice amount should be between 200.00 and 500.00. Controls 230 and 232 also allow the user to, respectively, delete or save condition 220.

The no path for condition 220 includes an action 236, indicating that approval should be requested from a particular individual (Benedict John). Action 236 is followed in the workflow by a stop action 240, indicating that the workflow ends.

The yes path for condition 220 includes another condition 234, which indicates an invoice amount between 200 and 300. The yes path for condition 234 includes an action, indicating that approval should be requested from a particular individual (Martin Gerard). Action 242 is followed in the workflow by a stop action 244, indicating that the workflow ends. The no path for condition 234 includes an action 246, indicating that approval should be requested from a particular individual (Daniel Shelby). Action 236 is followed in the workflow by a stop action 248, indicating that the workflow ends.

According to embodiments described herein, the workflow configuration specified via user interface screen 200 is used to generate a compressed decision model object for resource-efficient workflow processing. An example of such a decision model object is described below with respect to FIG. 3. The use of a single decision model object that is configured in a particular serialized manner for all of the conditions in the workflow provides many benefits, such as reduced computing resource utilization and scalability. Such a decision model object may then be used to efficiently reconstruct a visual representation of the workflow such as that shown in user interface screen 200 for display to the user, such as for review and/or additional configuration.

The conditions and actions described herein are included as examples, and many other types of conditions and actions are possible. For example, conditions may relate to geographic locations, occupations, categories, statuses, values, performance metrics, security conditions, sensor data, and/or any other number of variables, whether related to invoices or some other type of workflow.

It is noted that user interface screen 200 is included as an example, and other types of user interface screens and/or methods of receiving workflow configuration data may alternatively be employed using techniques described herein.

### Example Decision Model Object

FIG. 3 is an illustration of an example decision model object 300 for resource-efficient workflow processing as described herein. For example, decision model object 300 may be an example of a decision model object 142 of FIG. 1, and may have been generated by workflow processing engine 124 of FIG. 1, such as based on workflow configuration data shown in user interface screen 200 of FIG. 2. Decision model object 300 generally represents the decision logic shown in the workflow configuration of user interface screen 200 of FIG. 2. Each entry of decision model object 300 represents a branch of such logic. In certain embodiments, each index value in decision model object 300 corresponds to a particular condition (e.g., condition 204 of FIG. 2) and the entries containing that index value represent a sequential path through the logic of that condition. For example, a first entry with a given index value may represent the yes path for that condition and a second entry with the given index value may represent the no path for that condition (or an alternative yes path, such as if the condition includes an “or” statement between two alternative condition). If there are multiple alternative yes path entries with the given entry, then the entry or entries following the yes path entries represent the no path (which may also include one or more entries representing one condition or multiple alternative conditions separated by “or” statements). While not shown, an entry may have more than one condition, such as if a condition in a workflow has two separate conditions joined by an “and” statement. For example, an additional column (not shown) may be added for each additional condition of an entry, or multiple conditions may be included in a single column of the entry. Conditions may also relate to different types. For example, one or more conditions may relate to a geographic location rather than a transaction amount, and may be represented in a different column than conditions related to transaction amount.

Entry 1 of decision model object 300 generally represents the yes path of condition 204 of FIG. 2. Entry 1 includes an index value (that is an integer value) of 0, a condition specifying a transaction amount (that is a double value) of [0-100], and an output (decision result, which is a string) that indicates an action identifier, SendForApproval1. As described in more detail below with respect to FIG. 4, the action identifier SendForApproval1 may be mapped to action logic in a business process model object (in this case, SendForApproval1 would be mapped to the action of sending an invoice for approval to Elizabeth Lane, as specified in action 206 on the yes path for condition 204 in FIG. 2).

Entry 2 of decision model object 300 generally represents the no path of condition 204 of FIG. 2. Entry 2 includes an index value of 0, an empty condition (meaning that the output is a default value that will always be output), and an output (decision result) that indicates an index value of 2. Thus, entry 2 indicates that the no path for the condition associated with index 0 (condition 204 of FIG. 2) leads to another condition that is associated with index 2. Generally, if the yes path for a given condition associated with a given index i leads to another condition, the index of that other condition may be calculated as 2i+1, and if the no path for the given condition leads to another condition, the index of that other condition may be calculated as 2i+2. Thus, in this case, since the no path of the condition corresponding to index 0 leads to another condition (condition 220 of FIG. 2), the index of that other condition is calculated as 2(0)+2=2.

Accordingly, Entry 3 has an index value of 2 and generally represents the yes path of condition 220 of FIG. 2. Entry 3 includes an index value of 2, a condition specifying a transaction amount of [200-500], and an output (decision result) that indicates an index value of 5. In this case, since the yes path of the condition corresponding to index 2 leads to another condition (condition 234 of FIG. 2), the index of that other condition is calculated as 2(2)+1=5.

Entry 4 has an index value of 2 and generally represents the no path of condition 220 of FIG. 2. Entry 4 includes an index value of 2, no condition (meaning that the output is a default value that will always be output), and an output (decision result) that indicates an action identifier, SendForApproval2. As described in more detail below with respect to FIG. 4, the action identifier SendForApproval2 may be mapped to action logic in a business process model object (in this case, SendForApproval2 would be mapped to the action of sending an invoice for approval to Benedict John, as specified in action 236 on the no path for condition 220 in FIG. 2).

Entry 5 has an index value of 5 and generally represents the yes path of condition 234 of FIG. 2. Entry 5 includes an index value of 5, a condition specifying a transaction amount of [200-500], and an output (decision result) that indicates an action identifier, SendForApproval3. As described in more detail below with respect to FIG. 4, the action identifier SendForApproval3 may be mapped to action logic in a business process model object (in this case, SendForApproval3 would be mapped to the action of sending an invoice for approval to Martin Gerard, as specified in action 242 on the yes path for condition 234 in FIG. 2).

Entry 6 has an index value of 5 and generally represents the no path of condition 234 of FIG. 2. Entry 6 includes an index value of 5, no condition (meaning that the output is a default value that will always be output), and an output (decision result) that indicates an action identifier, SendForApproval4. As described in more detail below with respect to FIG. 4, the action identifier SendForApproval4 may be mapped to action logic in a business process model object (in this case, SendForApproval4 would be mapped to the action of sending an invoice for approval to Daniel Shelby, as specified in action 246 on the no path for condition 234 in FIG. 2).

Constructing decision model object 300 in this way allows for resource-efficient processing of a multi-condition workflow and resource-efficient reconstruction of a visual representation of the multi-condition workflow.

For example, in order to process the workflow, decision model object 300 may be traversed according to the following logic. Traversal begins at the first entry, and the condition of that entry is evaluated in order to determine whether the output of that entry applies. For example, the workflow processing engine may determine whether an invoice has a transaction amount in the range of [0-100] as specified in the condition of entry 1. If the invoice has a transaction amount in the range of [0-100], then the output of entry 1 is SendForApproval1, meaning that the action SendForApproval1 should be performed. If an action identifier is the only output of an entry, then the workflow may end after performing that action. Alternatively (not shown), an output may specify both an action identifier and another index value, meaning that the action corresponding to the action identifier should be performed and traversal should also proceed to that other index value (e.g., if another action or condition follows that action in the workflow).

If the invoice does not have a transaction amount in the range of [0-100], then traversal proceeds to the next sequential entry following the current entry. In such a case, traversal would proceed to entry 2. For example, the workflow processing engine may determine that no condition is specified for entry 2, and so the output of entry 2 is a default output. In this case, the output of entry 2 is another index value, 2. Thus, traversal proceeds to the first entry having an index value of 2. In this case, entry 3 is the first entry having an index value of 2.

To process entry 3, the workflow processing engine may determine whether an invoice has a transaction amount in the range of [200-500] as specified in the condition of entry 3. If the invoice has a transaction amount in the range of [200-500], then the output of entry 3 is the index value 5, meaning that traversal should proceed to the first entry having an index value of 5.

If the invoice does not have a transaction amount in the range of [200-500], then traversal proceeds to the next sequential entry following the current entry. In such a case, traversal would proceed to entry 4. For example, the workflow processing engine may determine that no condition is specified for entry 4, and so the output of entry 4 is a default output. In this case, the output of entry 4 is SendForApproval2, meaning that the action SendForApproval2 should be performed.

To process entry 5 (e.g., if traversal proceeded to the first entry having an index value of 5, such as if the invoice has a transaction amount in the range of [200-500] when that condition was evaluated at entry 3), the workflow processing engine may determine whether an invoice has a transaction amount in the range of [200-300] as specified in the condition of entry 5. If the invoice has a transaction amount in the range of [200-300], then the output of entry 5 is SendForApproval3, meaning that the action SendForApproval3 should be performed.

If the invoice does not have a transaction amount in the range of [200-300], then traversal proceeds to the next sequential entry following the current entry. In such a case, traversal would proceed to entry 6. For example, the workflow processing engine may determine that no condition is specified for entry 6, and so the output of entry 6 is a default output. In this case, the output of entry 6 is SendForApproval4, meaning that the action SendForApproval4 should be performed.

If an action identifier (e.g., SendForApproval1, SendForApproval2, SendForApproval3, or SendForApproval4) is output as a result of traversing decision model object 300, then a business process model object may be used to map that action identifier to action logic for performing the action. Otherwise, if no action identifier is output, then the workflow may end. In some cases a last entry of a decision model object may include a final default output that will always be returned if no other output is reached (e.g., a blank output), if appropriate according to the logic of the workflow. In one example, the last entry outputs an exit code as a default output, thereby ending the workflow without performing an action.

Furthermore, decision model object 300 may be used to reconstruct a workflow language for use in generating a visual representation of the workflow. For example, knowing the sequential manner in which decision model object 300 is configured, the workflow processing engine may traverse through decision model object 300 in order to determine all conditions in the workflow and the outputs (e.g., action identifiers or other conditions) of the yes and no paths for each condition. In some embodiments, the workflow processing engine may begin with entry 1 in order to identify the first condition and the yes path for the first condition, and may proceed to entry 2 to identify the no path for the first condition (and so on). For example, the workflow processing engine may know that each condition is associated with its own index value, and so may process the entries having that index value sequentially in order to determine the outputs of the yes and no paths for that condition. Having determined al condition in the workflow and the outputs for the yes and no paths for each condition, the workflow processing engine can map any action identifiers to action logic using a business process model object, and may then generate a visual representation of the workflow using all of this information (e.g., such as the visual representation shown in FIG. 2). For instance, the workflow processing engine may create a box or other type of visual element to represent each condition (e.g., with text indicating the condition), arrows to represent a yes and no path for each condition (e.g., with text of the words YES and NO), a box or other type of visual element to represent each action (e.g., with text indicating the action), and a box or other visual element to represent stop actions where the workflow ends. In some embodiments, the workflow processing engine may generate an initial box or other visual element representing the beginning of the workflow, such as indicating that an invoice is created.

While certain examples are described herein with respect to binary conditions for ease of understanding, it is understood that techniques described herein may also be implemented for n-ary conditions. For example, if there are more than two branches from a given condition, then those multiple branches may be represented by sequential entries in a decision model object in a similar manner to that shown and discussed with respect to the binary conditions herein. For example, a first one or more entries for a condition may have the index value of the condition and may represent a first branch of logic for the condition, a second one or more entries for the condition may have the index value of the condition and may represent a second branch of logic for the condition, a third one or more entries for the condition may have the index value of the condition and may represent a third branch of logic for the condition, and so on.

While existing techniques involve creating a separate decision model object for each condition (e.g., without the indexing logic described herein for supporting multiple conditions in a single decision model object), embodiments of the present disclosure provide improved efficiency and functionality by utilizing a single decision model object with an efficiently traversable configuration to represent multiple conditions of a single workflow, thereby improving workflow functionality as well as the software applications and computing devices involved.

The depicted examples involve only a relatively small number of binary conditions, but workflows can be far more complex, such as involving hundreds of binary and/or n-ary conditions. In such cases, the resource-efficiencies achieved by techniques described herein provide even more pronounced improvements in performance and functionality.

### Example Business Process Model Object

FIG. 4 is an illustration of an example business process model object 400 according to techniques described herein.

Business process model object 400 includes a transaction rule evaluation 402 that branches into several paths representing different actions that can be taken as a result of transaction rule evaluation 402. For example, transaction rule evaluation 402 may involve processing a decision model object such as decision model object 300 of FIG. 3 as described above.

If the output of transaction rule evaluation 402 is the action identifier SendForApproval1, then action 404 is performed. Action 404 includes logic for performing the action identified by SendForApproval1, and involves sending an invoice for approval to Elizabeth Lane. While not shown, action 404 may specify how the invoice is to be sent to Elizabeth Lane, such as an email address.

If the output of transaction rule evaluation 402 is the action identifier SendForApproval2, then action 406 is performed. Action 406 includes logic for performing the action identified by SendForApproval2, and involves sending an invoice for approval to Benedict Moore. While not shown, action 406 may specify how the invoice is to be sent to Benedict Moore, such as an email address.

If the output of transaction rule evaluation 402 is the action identifier SendForApproval3, then action 408 is performed. Action 408 includes logic for performing the action identified by SendForApproval3, and involves sending an invoice for approval to Martin Gerard. While not shown, action 408 may specify how the invoice is to be sent to Martin Gerard, such as an email address.

If the output of transaction rule evaluation 402 is the action identifier SendForApproval4, then action 410 is performed. Action 410 includes logic for performing the action identified by SendForApproval4, and involves sending an invoice for approval to Daniel Shelby. While not shown, action 410 may specify how the invoice is to be sent to Daniel Shelby, such as an email address.

An application configured to perform a workflow as described herein may then perform one or more actions indicated in the workflow when one or more conditions specified in the workflow occur. For example, processing the workflow using decision model object 300 of FIG. 3 and business process model object 400 of FIG. 4 may cause the application to perform an action (e.g., automatically requesting approval from Martin Gerard, such as via an email address, phone number, user interface, and/or the like) when an invoice is created or edited that specifies an invoice amount between 200 and 500 and also between 200 and 300. Requesting approval from an individual is included as one example of an action, and many other types of actions may also be specified in workflows. For example, actions may include activating or deactivating software application features, initiating or terminating processes, controlling smart devices, generating alerts or messages, causing content to be displayed or hidden, deleting files, allowing or disallowing particular communications or other activities, performing an automated security or health check, opening a support ticket, initiating an automated or assisted support session, and/or the like. Conditions may, for example, include any types of conditions that specify particular values or ranges of values, whether numerical or non-numerical.

### Example Method for Compressed Decision Model Object Generation and Processing

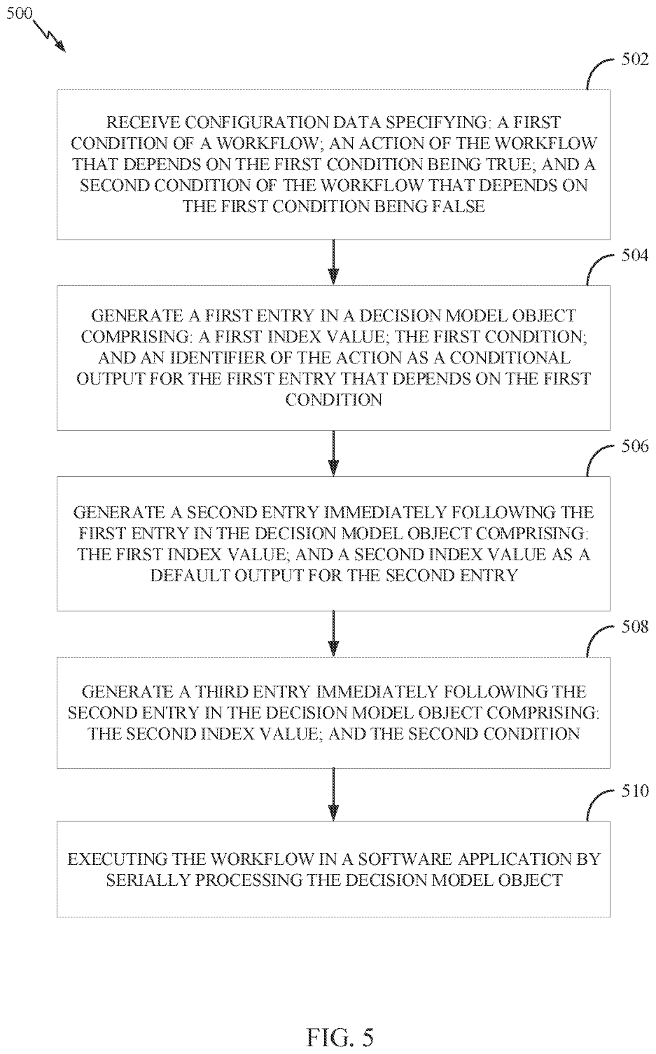

FIG. 5 depicts example operations 500 related to compressed decision model object generation and processing according to embodiments of the present disclosure. For example, operations 500 may be performed by one or more components described above with respect to computing environment 100 of FIG. 1.

Operations 500 begin at step 502, with receiving configuration data specifying: a first condition of a workflow; an action of the workflow that depends on the first condition being true; and a second condition of the workflow that depends on the first condition being false. In some embodiments, the configuration data is received via a user interface.

Operations 500 continue at step 504, with generating a first entry in a decision model object comprising: a first index value; the first condition; and an identifier of the action as a conditional output for the first entry that depends on the first condition.

Operations 500 continue at step 506, with generating a second entry immediately following the first entry in the decision model object comprising: the first index value; and a second index value as a default output for the second entry.

Operations 500 continue at step 508, with generating a third entry immediately following the second entry in the decision model object comprising: the second index value; and the second condition.

Operations 500 continue at step 510, with executing the workflow in a software application by serially processing the decision model object.

In some embodiments, executing the workflow in the software application by serially processing the decision model object comprises: processing the first entry; determining that the first condition is not true; moving to processing of the second entry upon determining that the first condition is not true based on the second entry immediately following the first entry in the decision model object; identifying the second index value as the default output of the second entry; and moving to processing of the third entry based on determining that the third entry corresponds to the second index value.

In some embodiments, the configuration data further specifies an additional action of the workflow that depends on the second condition being true, and the third entry further comprises an identifier of the additional action as a conditional output of the third entry.

Certain embodiments further comprise displaying a visual representation of the workflow based on parsing the decision model object to generate a worfklow representation.

Some embodiments further comprise generating a business process model object that maps the identifier of the action to logic for performing the action. For example, executing the workflow in the software application by serially processing the decision model object may further comprise determining, based on the serially processing of the decision model object, that the identifier of the action is an output of the first entry and using the business process model object to determine the logic for performing the action based on the identifier of the action. The action may then be performed using the logic.

In some embodiments, executing the workflow in the software application by serially processing the decision model object does not require processing any additional decision model objects.

### Example Computing Systems

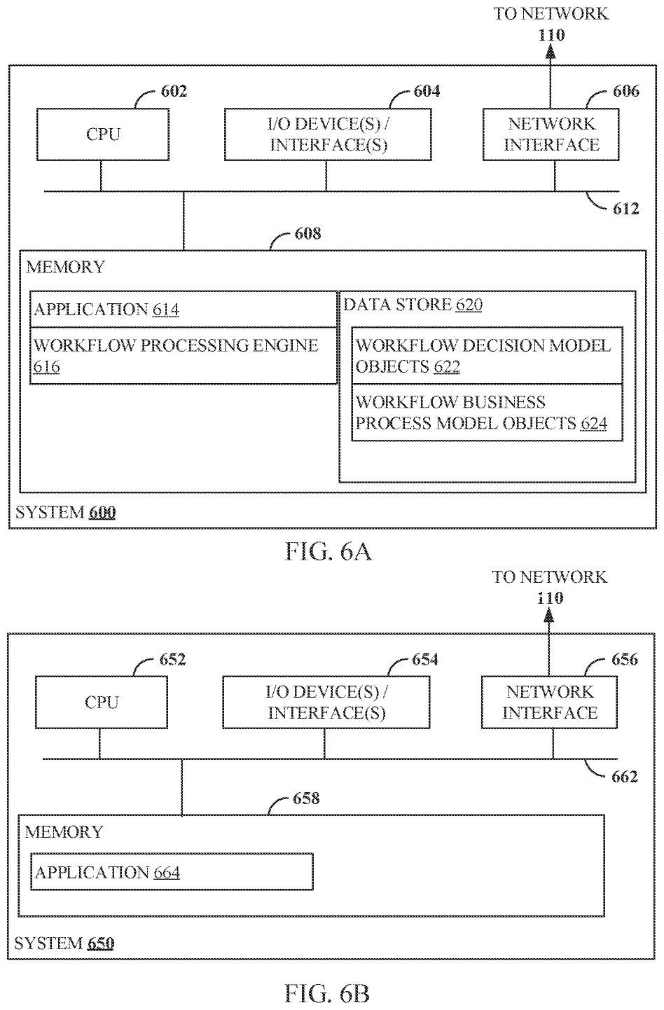

FIG. 6A illustrates an example computing system 600 with which embodiments of the disclosure related to compressed decision model object generation and processing may be implemented. For example, the computing system 600 may be representative of server 120 of FIG. 1.

The computing system 600 includes a central processing unit (CPU) 602, one or more I/O device interfaces 604 that may allow for the connection of various I/O devices 604 (e.g., keyboards, displays, mouse devices, pen input, etc.) to the computing system 600, a network interface 606, a memory 608, and an interconnect 612. It is contemplated that one or more components of the computing system 600 may be located remotely and accessed via a network 610. It is further contemplated that one or more components of the computing system 600 may include physical components or virtualized components.

The CPU 602 may retrieve and execute programming instructions stored in the memory 608. Similarly, the CPU 602 may retrieve and store application data residing in the memory 608. The interconnect 612 transmits programming instructions and application data, among the CPU 602, the I/O device interface 604, the network interface 606, the memory 608. The CPU 602 is included to be representative of a single CPU, multiple CPUs, a single CPU having multiple processing cores, and other arrangements.

Additionally, the memory 608 is included to be representative of a random access memory or the like. In some embodiments, the memory 608 may include a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, the memory 608 includes application 614, workflow processing engine 616, and data store 620 including workflow decision model objects 622 and workflow business process model objects 624, which may be representative of application 122, workflow processing engine 124, data store 140, workflow decision model objects 142, and workflow business process model objects 144 of FIG. 1.

FIG. 6B illustrates an example computing system 650 with which embodiments of the system related to automatically recommending items for selection with a software application through machine learning may be implemented. For example, the computing system 650 may be representative of client 130 of FIG. 1.

The computing system 650 includes a central processing unit (CPU) 652, one or more I/O device interfaces 654 that may allow for the connection of various I/O devices 654 (e.g., keyboards, displays, mouse devices, pen input, etc.) to the computing system 650, a network interface 656, a memory 658, and an interconnect 660. It is contemplated that one or more components of the computing system 650 may be located remotely and accessed via a network 662. It is further contemplated that one or more components of the computing system 650 may include physical components or virtualized components.

The CPU 652 may retrieve and execute programming instructions stored in the memory 658. Similarly, the CPU 652 may retrieve and store application data residing in the memory 658. The interconnect 660 transmits programming instructions and application data, among the CPU 652, the I/O device interface 654, the network interface 656, the memory 658. The CPU 652 is included to be representative of a single CPU, multiple CPUs, a single CPU having multiple processing cores, and other arrangements.

Additionally, the memory 658 is included to be representative of a random access memory or the like. In some embodiments, the memory 658 may include a disk drive, solid state drive, or a collection of storage devices distributed across multiple storage systems. Although shown as a single unit, the memory 658 may be a combination of fixed and/or removable storage devices, such as fixed disc drives, removable memory cards or optical storage, network attached storage (NAS), or a storage area-network (SAN).

As shown, the memory 658 may include an application 664, such as a user-side application (e.g., comprising a user interface) discussed above with respect to client 130 of FIG. 1.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for compressed decision model object generation and processing, the method comprising:
receiving configuration data specifying:
a first condition of a workflow;
an action of the workflow that depends on the first condition being true; and
a second condition of the workflow that depends on the first condition being false;
generating a first entry in a decision model object comprising:
a first index value;
the first condition; and
an identifier of the action as a conditional output for the first entry that depends on the first condition;
generating a second entry immediately following the first entry in the decision model object comprising:
the first index value; and
a second index value as a default output for the second entry;
generating a third entry immediately following the second entry in the decision model object comprising:
the second index value; and
the second condition; and
executing the workflow in a software application by serially processing the decision model object.

2. The method of claim 1, wherein executing the workflow in the software application by serially processing the decision model object comprises:
processing the first entry;
determining that the first condition is not true;
moving to processing of the second entry upon determining that the first condition is not true based on the second entry immediately following the first entry in the decision model object;
identifying the second index value as the default output of the second entry; and
moving to processing of the third entry based on determining that the third entry corresponds to the second index value.

3. The method of claim 2, further comprising displaying a visual representation of the workflow based on parsing the decision model object to generate a worfklow representation.

4. The method of claim 2, wherein the configuration data further specifies an additional action of the workflow that depends on the second condition being true, and wherein the third entry further comprises an identifier of the additional action as a conditional output of the third entry.

5. The method of claim 1, wherein the configuration data is received via a user interface.

6. The method of claim 1, further comprising generating a business process model object that maps the identifier of the action to logic for performing the action.

7. The method of claim 6, wherein executing the workflow in the software application by serially processing the decision model object comprises:
determining, based on the serially processing of the decision model object, that the identifier of the action is an output of the first entry;
using the business process model object to determine the logic for performing the action based on the identifier of the action; and
performing the action using the logic.

8. The method of claim 7, wherein executing the workflow in the software application by serially processing the decision model object does not require processing any additional decision model objects.

9. A system for compressed decision model object generation and processing, comprising:
one or more processors; and
a memory storing instructions that, when executed by the one or more processors, cause the system to:
receive configuration data specifying:
a first condition of a workflow;
an action of the workflow that depends on the first condition being true; and
a second condition of the workflow that depends on the first condition being false;
generate a first entry in a decision model object comprising:
a first index value;
the first condition; and
an identifier of the action as a conditional output for the first entry that depends on the first condition;
generate a second entry immediately following the first entry in the decision model object comprising:
the first index value; and
a second index value as a default output for the second entry;
generate a third entry immediately following the second entry in the decision model object comprising:
the second index value; and
the second condition; and
execute the workflow in a software application by serially processing the decision model object.

10. The system of claim 9, wherein executing the workflow in the software application by serially processing the decision model object comprises:
processing the first entry;
determining that the first condition is not true;
moving to processing of the second entry upon determining that the first condition is not true based on the second entry immediately following the first entry in the decision model object;
identifying the second index value as the default output of the second entry; and
moving to processing of the third entry based on determining that the third entry corresponds to the second index value.

11. The system of claim 10, wherein the instructions, when executed by the one or more processors, further cause the system to display a visual representation of the workflow based on parsing the decision model object to generate a worfklow representation.

12. The system of claim 10, wherein the configuration data further specifies an additional action of the workflow that depends on the second condition being true, and wherein the third entry further comprises an identifier of the additional action as a conditional output of the third entry.

13. The system of claim 9, wherein the configuration data is received via a user interface.

14. The system of claim 9, wherein the instructions, when executed by the one or more processors, further cause the system to generate a business process model object that maps the identifier of the action to logic for performing the action.

15. The system of claim 14, wherein executing the workflow in the software application by serially processing the decision model object comprises:
determining, based on the serially processing of the decision model object, that the identifier of the action is an output of the first entry;
using the business process model object to determine the logic for performing the action based on the identifier of the action; and
performing the action using the logic.

16. The system of claim 15, wherein executing the workflow in the software application by serially processing the decision model object does not require processing any additional decision model objects.

17. A non-transitory computer readable medium comprising instructions that, when executed by one or more processors of a computing system, cause the computing system to:
receive configuration data specifying:
a first condition of a workflow;
an action of the workflow that depends on the first condition being true; and
a second condition of the workflow that depends on the first condition being false;
generate a first entry in a decision model object comprising:
a first index value;
the first condition; and
an identifier of the action as a conditional output for the first entry that depends on the first condition;
generate a second entry immediately following the first entry in the decision model object comprising:
the first index value; and
a second index value as a default output for the second entry;
generate a third entry immediately following the second entry in the decision model object comprising:
the second index value; and
the second condition; and
execute the workflow in a software application by serially processing the decision model object.

18. The non-transitory computer readable medium of claim 17, wherein executing the workflow in the software application by serially processing the decision model object comprises:
processing the first entry;
determining that the first condition is not true;
moving to processing of the second entry upon determining that the first condition is not true based on the second entry immediately following the first entry in the decision model object;
identifying the second index value as the default output of the second entry; and
moving to processing of the third entry based on determining that the third entry corresponds to the second index value.

19. The non-transitory computer readable medium of claim 18, wherein the instructions, when executed by the one or more processors of a computing system, further cause the computing system to display a visual representation of the workflow based on parsing the decision model object to generate a worfklow representation.

20. The non-transitory computer readable medium of claim 18, wherein the configuration data further specifies an additional action of the workflow that depends on the second condition being true, and wherein the third entry further comprises an identifier of the additional action as a conditional output of the third entry.
